(19) United States
(12) Patent Application Publication
(10) Pub. No.: US 2014/0019367 A1
(43) Pub. Date: Jan. 16, 2014

(54) METHOD TO SEND PAYMENT DATA THROUGH VARIOUS AIR INTERFACES WITHOUT COMPROMISING USER DATA

(71) Applicant: APPLE INC., Cupertino, CA (US)

(72) Inventors: Ahmer A. KHAN, Milpitas, CA (US); Brian J. Tucker, Sunnyvale, CA (US); David T. Haggerty, San Francisco, CA (US); Scott M. Herz, San Jose, CA (US)

(73) Assignee: Apple Inc., Cupertino, CA (US)

(21) Appl. No.: 13/631,838

(22) Filed: Sep. 28, 2012

Related U.S. Application Data
(60) Provisional application No. 61/671,677, filed on Jul. 13, 2012.

(51) Int. Cl. G06Q 30/06; H04L 9/32; H04L 9/28

(52) U.S. Cl. 705/75; 705/16; 705/78

(57) ABSTRACT

A commercial transaction method is disclosed. The method first establishes a secure link over a first air interface by a purchasing device. This secure link is between the purchasing device and a point of sale device. The method further identifies a second air interface, which is different from the first air interface, and the second air interface is used to conduct a secure commercial transaction.

### CROSS REFERENCE TO RELATED APPLICATIONS

This application claims priority to U.S. Provisional Patent Application No. 61/671,677, filed Jul. 13, 2012, and entitled “METHOD TO SEND PAYMENT DATA THROUGH VARIOUS AIR INTERFACES WITHOUT COMPROMISING USER DATA,” which is incorporated herein by reference in its entirety and for all purposes.

### TECHNICAL FIELD

The described embodiments generally relate to methods and apparatuses for conducting a wireless commercial transaction that is both user friendly and secure.

### BACKGROUND

Devices located in close proximity to each other can communicate directly using proximity technologies such as Near-Field Communications (NFC), Radio Frequency Identifier (RFID), and the like. These protocols can establish wireless communication links between devices quickly and conveniently, without, for example, performing setup and registration of the devices with a network provider. NFC can be used in electronic transactions, e.g., to securely send order and payment information for online purchases from a purchaser's mobile device to a seller's point of sale (POS) device.

Currently, payment information such as credit card data in mobile devices is sent directly from a secure element (SE) located in a device such as a mobile phone through proximity interfaces, such as near field communications (NFC), without an associated application processor (AP), such as an application program in the device, accessing the payment information. Preventing the AP from accessing the sensitive payment information is necessary because current payment schemes use real payment information (credit card number, expiration date, etc.) that can be used to make purchases through other means, include online and via the phone, and data in the AP can be intercepted and compromised by rogue applications.

Thus, there exists a need for a secure method of executing a commercial transaction that is both secure and user friendly.

### SUMMARY

In one or more embodiments, a portable device can make purchases by using near field communications (NFC) to establish a secure link with a point of sale (POS) device connected to a backend system that is configured to execute commercial transactions. This secure link can be established by positioning the portable device to be within close proximity of the point of sale device. Increased mobility is provided to users of the portable device making purchases by establishing a second secure link that uses a different protocol, such as WIFI or Bluetooth, that has more desirable characteristics for maintaining the link over time than NFC.

In one or more embodiments, a second secure link is established using a shared secret known to the portable device and the backend server, and using an alias to identify a purchasing account such as a credit card. When a request to make a transaction using the credit card is submitted to the backend server, the server determines whether the combination of the alias and crypto data is valid using a shared secret that is known to a secure element in the portable device and the backend server. The backend server uses the shared secret (e.g., symmetric keys, public private keys, etc.) to verify the alias and the crypto data. The backend receives the alias from the portable device via the point of sale device and combines the alias with other information, such as counter value known to both the backend and the secure element 108. The backend can then generate the same crypto data using the shared secret and received data, and compare the result with the received crypto data. If the comparison indicates that the values are the same, then the credit card that corresponds to the credit card alias is provided back to the partner, and the transaction proceeds as normal. Otherwise, the credit card alias is rejected and the transaction is denied.

In one or more embodiments, a method of performing a commercial transaction is provided. The method includes establishing a first secure link over a first air interface by a purchasing device, the first secure link between the purchasing device and a point of sale device, identifying a second air interface different from the first air interface, establishing a second secure link over a second air interface, the second secure link between the purchasing device and a backend server, and conducting, using the second air interface, a secure commercial transaction between the purchasing device and the backend server using payment data secured by a shared secret known to a secure element in the purchasing device and to the backend server.

Embodiments of the invention may include one or more of the following features. The payment data may include an alias associated with a payment account, and establishing the second secure link may include encrypting the payment data by the secure element at the purchasing device using the shared secret as an encryption key. Establishing the second secure link may include decrypting, at the backend server, the payment data using the shared secret, and verifying, at the backend server, the payment data, where verifying includes comparing the payment data to independently known payment data stored at the backend server. Comparing the payment data to independently known payment data may include retrieving an alias from the decrypted received payment data, identifying a credit card account associated with the alias, determining if the alias is associated with the credit card account according to an association stored in a memory of the backend server, and, in response to determining that the alias is associated with the credit card account, approving the commercial transaction. Comparing the payment data may further include retrieving a counter value from the decrypted retrieved payment data, and comparing the counter value to an independently known counter value stored in a memory of the backend server. Establishing the first secure link may include establishing a near field communication link between the purchasing device and the point of sale device. Identifying a second air interface different from the first air interface may include identifying an air interface having properties more desirable than the first air interface to communicate data to a user over a time period longer than the time used to establish the first secure link.

### BRIEF DESCRIPTION OF THE DRAWINGS

The described embodiments and the advantages thereof may best be understood by reference to the following description taken in conjunction with the accompanying drawings.

FIG. 1 illustrates a wireless system in accordance with the described embodiments.

FIG. 2 further illustrates a wireless system in accordance with the described embodiments.

FIG. 3 illustrates a flow chart of a secure method of executing a commercial transaction in accordance with the described embodiments.

FIG. 4 illustrates a method of making mobile payments online in accordance with the described embodiments.

FIG. 5 illustrates a method of making mobile payments offline in accordance with the described embodiments.

FIG. 6 shows a system block diagram of computer system used to execute the software of an embodiment.

### DETAILED DESCRIPTION OF SELECTED EMBODIMENTS

In the following description, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

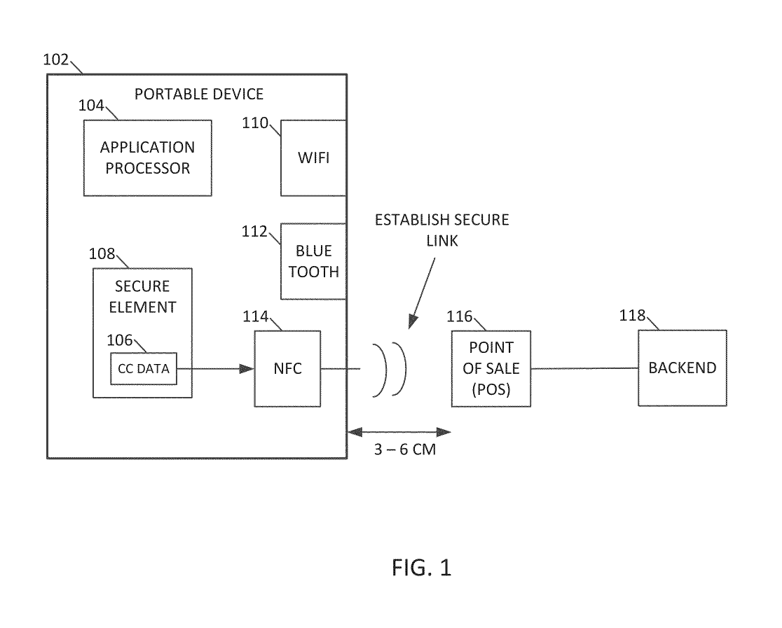

FIG. 1 shows a portable device 102 that includes a secure element (SE) 108 configured to securely store and provide access to credit card information 106 in accordance with one or more embodiments. The device 102 also includes an application processor (AP) 104 that executes applications to, for example, purchase goods and services using the credit card information 106 to send payments to vendor systems such as a point of sale (POS) device 116. The portable device 102 also includes one or more air interfaces, such as near field communications (NFC) 114, WIFI 110 (e.g., wireless local area network (WLAN) products that are based on the Institute of Electrical and Electronics Engineers' (IEEE) 802.11 standard) and Bluetooth (BT) 112. NFC 114, Bluetooth 112, and WIFI 110 are wireless communication protocols. In one example, the portable device can make purchases by using near field communications (NFC) to wirelessly establish a secure link with the point of sale (POS) device 116, which is connected to a backend system 118 configured to execute commercial transactions, e.g., a bank, acquirer, or the like. This secure link using NFC 114 can be established by positioning the portable device to be within close proximity of, within e.g., 3 to 6 cm of, the point of sale device 116. In this example, credit card information 106 is sent by the secure element 108 as plaintext (i.e., not encrypted) data directly to the NFC 114. The plaintext credit card data 106 is not sent to the application processor 104. If the plaintext credit card data 106 were to be sent to the application processor 104, a rogue program could access the credit card data 106 and use it to make unauthorized purchases. In the example of FIG. 1, access to the credit card data 106 by rogue programs is prevented because the communication between the secure element 108 and the NFC 114 is not accessible to the application processor 102.

In other embodiments, the portable device 102 can use protocols other than NFC to establish the secure link between the portable device 102 and the POS device 116, particularly protocols that have desirable characteristics for establishing a secure link, e.g., protocols that can establish a secure link quickly and securely. Protocols with desirable characteristics for establishing a secure link can have undesirable characteristics for maintaining the link over time, e.g., such protocols may involve keeping the portable device 102 in the same location for the duration of a transaction. The NFC protocol, for example, establishes a secure link quickly and conveniently at a point of sale. However, transactions that include sending additional data between the POS terminal 106 and the portable device 102, such as additional payment information, coupon offers, coupon data, and the like, can continue for some time, during which the portable device 102 is kept in the same location within centimeters of the POS terminal 116. Holding or setting the device 102 near the POS terminal 116 becomes inconvenient for users, so NFC is less desirable for longer transactions such as those that involve transferring more data than used by the payment information or use more time than used in the NFC connection establishment process. The establishment of the NFC link, which occurs quickly, is referred to herein as an initial “bump” because the devices may touch each other momentarily when the NFC connection is being established. NFC is used herein as an example, and other types of proximity technology can be used in other embodiments.

In one or more embodiments, the NFC secure link can be used to establish a second secure link that uses a different protocol, such as WIFI 110, Bluetooth 112, or another wireless protocol that has more desirable characteristics for maintaining the link over time than NFC. The particular protocol that is used for the second link can be selected based on configured information, e.g., depending on the type of communication hardware available in the device, or according to user preferences, signal strength, the amount of data expected to be transferred, and so on.

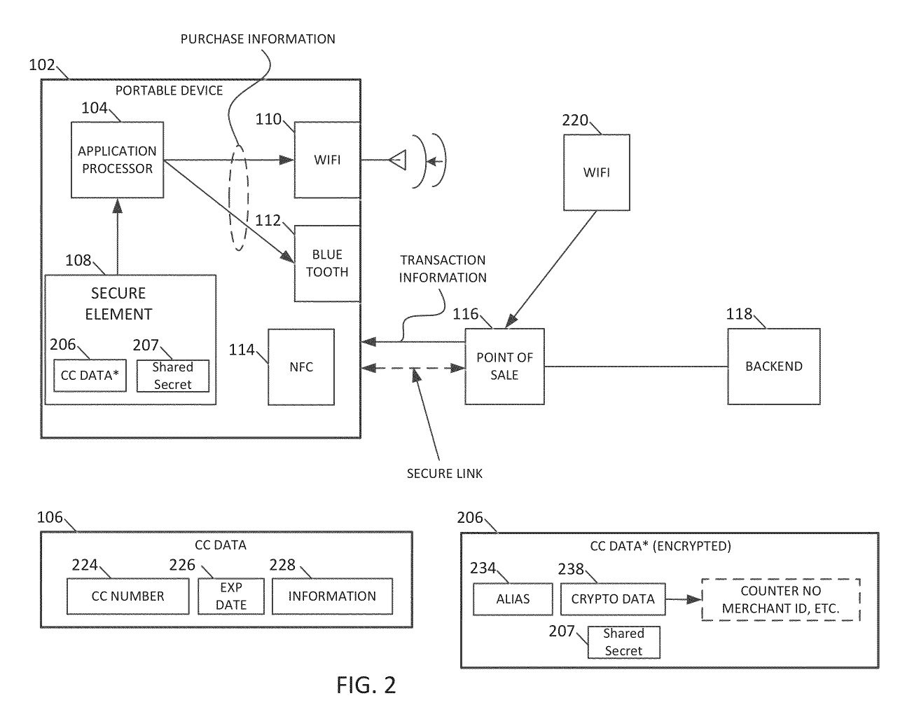

FIG. 2 shows the portable device 102 conducting a secure commercial transaction using a second air interface 110 or 112 in accordance with one or more embodiments. The second air interface 110 or 112 is different from the first air interface 114 that was used to establish the secure link. As an example, FIG. 2 shows the portable device 102 conducting a secure commercial transaction using the WIFI air interface 110, for a secure link that was established using NFC 114. In this way, purchase information may be transferred through the WIFI interface 110 instead of the NFC interface 114. WIFI is more convenient than NFC for users, since the limited communication range of NFC requires the portable device to be in close proximity to the POS device, e.g., within 3 to 6 inches. The second air interface 114 can be used, for example, to send information such as offers by customers or merchants, coupon offers and redemptions, receipts, follow up information, and so on. The second air interface 114 link can be closed upon completion of the transaction(s) by, for example, sending a completion or termination message.

FIG. 2 further shows the secure element 108 passing encrypted credit card data (CC data*) 206 to the application processor 104. Normal, i.e., plaintext, credit card data (CC data) 106 includes a credit card number, expiration date (exp date) and other information. Encrypted credit card data (CC data*) 206 includes an alias 234 and other cryptographic data 238 such as counter number, merchant ID, etc.

As described above, the confidentiality of data sent to the application processor 104 may be compromised, e.g., by a rogue application. Therefore, the credit card data 106 is encrypted by the secure element 108 to produce encrypted cryptographic data 206. The secure element 108 generates an “alias” 234 for the credit card data 206, which is passed to the application processor 104 instead of the unencrypted credit card data 106. The alias 234 is an identifier for the credit card data 206, but cannot be used to make a payment without valid crypto data 238 that corresponds to the alias 234. Thus, the alias need not be stored securely, because payments made with the alias 234 are not accepted by the backend 118 unless the corresponding crypto data 238 is also supplied, e.g., in a request to process a payment.

The crypto data 238 may be, for example, a digitally-signed combination of one or more of the alias 234, a counter value that is incremented for each alias value, a random number, a merchant identifier, or any other value that is believed to be important. The shared secret 207 may be, for example, a symmetric key distributed to the secure element 108 at the time the device 102 is manufactured, and loaded into the backend 118 via secure communication behind a firewall. In other embodiments, a cryptographic key exchange mechanism may be used to establish the shared secret. Therefore, the alias can be known by the application processor 104 without compromising security. The crypto data is, in one or more embodiments, stored in the secure element 108 and used to generate the crypto data 238 at the portable device 102 based upon the alias received from the application processor 104. A user may enter the alias 234 into the application processor 104, and the alias 234 is also known to the backend 118. The alias is, for example, provided to the user by the organization that operates the backend, e.g., an online merchant.

In one or more embodiments, when a request to make a transaction using the credit card is submitted to the backend server 414, the server 414 determines whether the combination of the alias 234 and crypto data 238 are valid using a shared secret 207 that is known to the secure element 108 and the backend server 118. The backend uses the shared secret (e.g., symmetric keys, public private keys, etc.) to verify the alias 234 and the crypto data 238. The backend 118 receives the alias from the portable device 102 via the point of sale 116, combines the alias 234 with other information as described above (e.g., a counter value known to both the backend 118 and the secure element 108, and so on). The backend 118 can then generate the same crypto data using the shared secret and received data, and compare the result with the received crypto data. If the comparison indicates that the values are the same, then the credit card that corresponds to the credit card alias 234 is provided back to the partner 412, and the transaction proceeds as normal. Otherwise, the credit card alias is rejected and the transaction is denied.

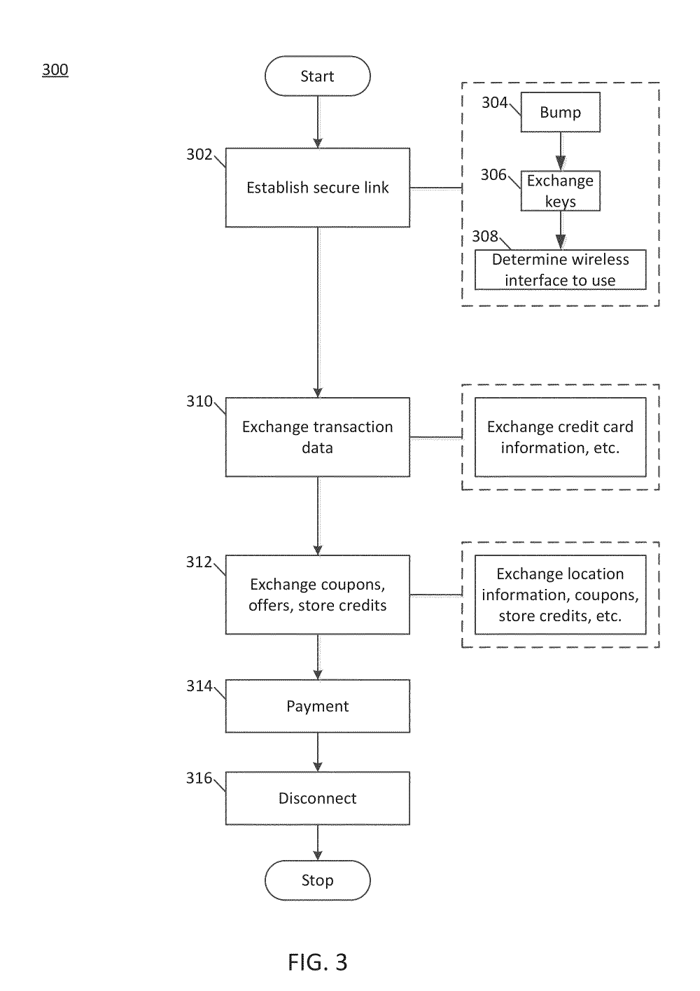

FIG. 3 shows the flow chart of an example method 300 to conduct a secure commercial transaction in accordance with one or more embodiments. The method 300 can be implemented as, for example, computer program code encoded on a computer readable medium and executable by a processor of a computer system.

The method 300 includes, at block 302 establishing a secure link between a portable device and a POS device, exchanging transaction data at block 310, and exchanging coupons, offers, store credits, location information, etc. at block 312 The method further includes making payment and disconnecting the portable device from the POS device. The establishing a secure link portion 302 includes establishing a bump 304, e.g., an NFC connection, exchanging keys as described above with reference to FIG. 2, and determining which wireless interface to use, e.g., NFC, RFID, or another interface. Exchanging transaction data includes exchanging credit card information, etc. as described above with reference to FIG. 2.

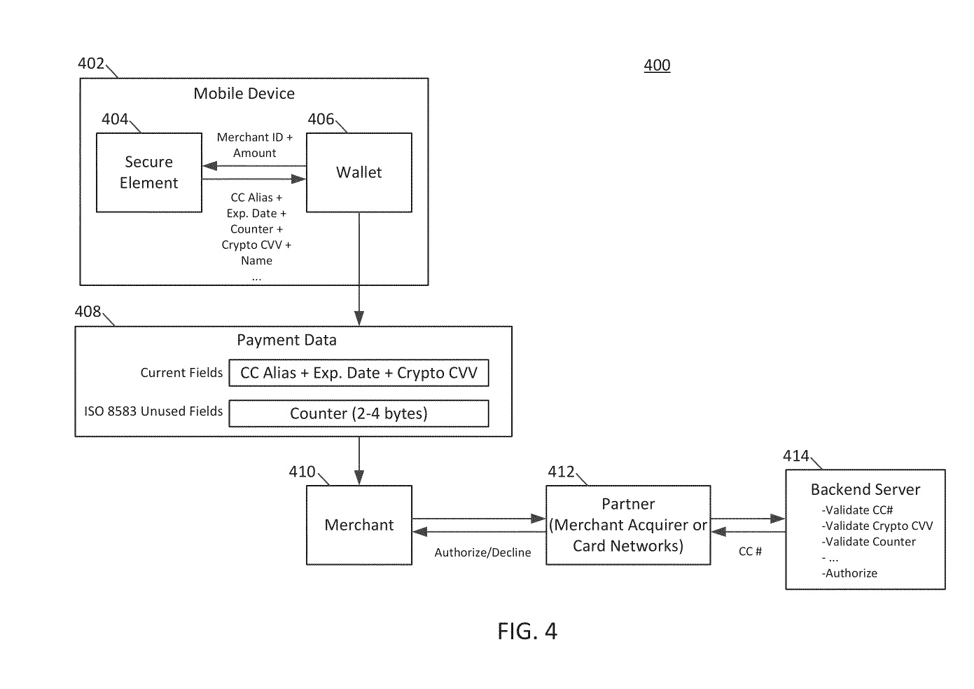

FIG. 4 shows an example method to make mobile payments online in accordance with one or more embodiments. A mobile device 402 includes a secure element 404 and a wallet 406, which is similar to the secure element 108 of FIG. 2. Payment data 408, including the credit card alias, expiration date, and crypto CVV (e.g., credit card security code) is sent to the merchant 410, which is analogous to the point of sale 116 of FIG. 2. The merchant 410 sends an authorization request to a partner 412, e.g., a credit card network, and a backend server validates the payment information, e.g., credit card number, CVV, counter, alias, and any other information using a secret key that is known to both the backend server 414 and the wallet 406. If the payment information matches corresponding values independently known to the backend server, then the server 414 authorizes the transaction. Otherwise, the transaction is declined.

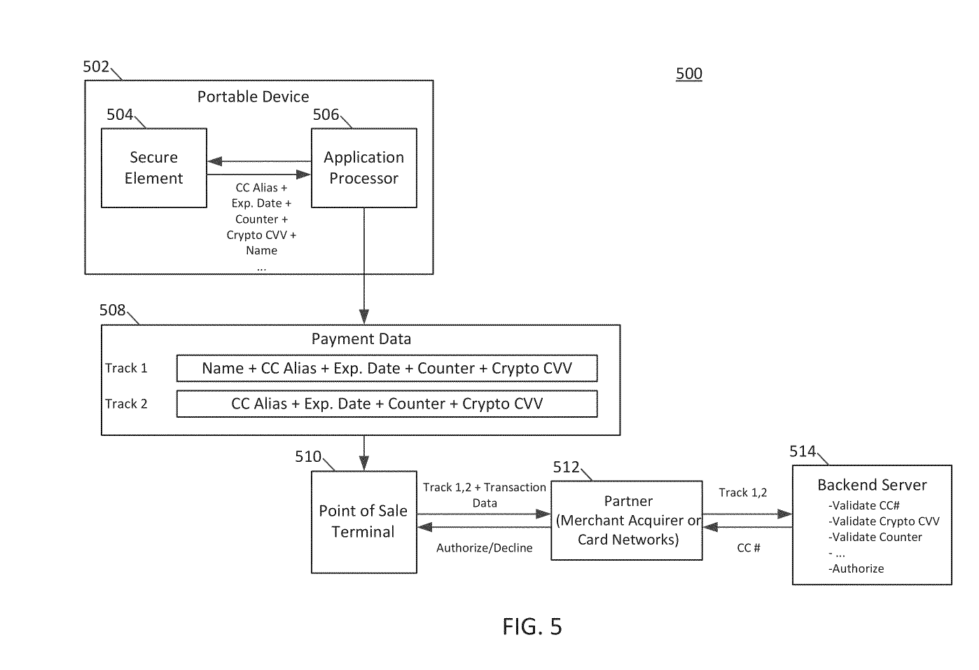

FIG. 5 shows an example method to make mobile payments offline (e.g., in store) in accordance with one or more embodiments. Block 502 is a portable device that includes a secure element 504 and an application processor 506 as described above with reference to FIG. 2. The application processor 506 sends payment data 408, e.g., credit card information including a name, alias, expiration data, counter, and security code, to a POS terminal 510. The POS terminal 510 forwards the payment data to a partner 512, e.g., a merchant acquirer, which in turn sends an authorization request to the backend 514. The backend authorizes the request if the received payment data has been encrypted with the same secret key 207 that is known to the backend 514, and the data that results from decrypting the received payment data matches corresponding values independently known to the backend server 514.

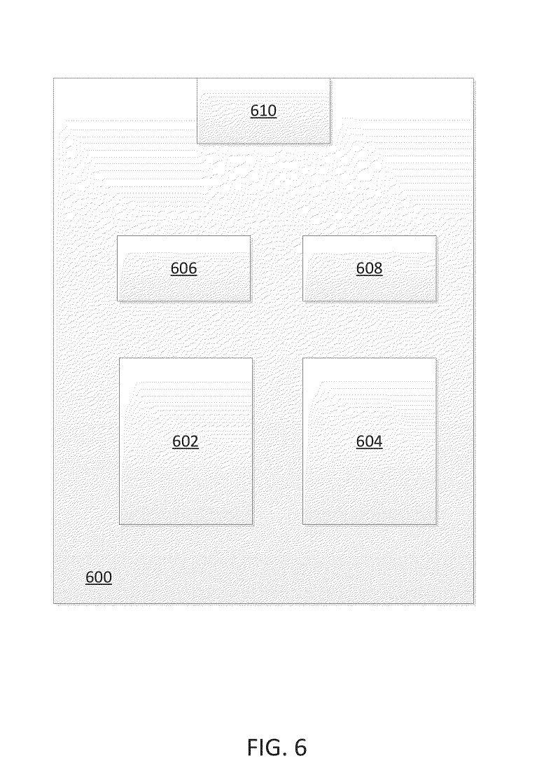

FIG. 6 shows a system block diagram of computer system 600 used to execute the software of an embodiment. Computer system 600 includes subsystems such as a central processor 602, system memory 604, fixed storage 606 (e.g., hard drive), removable storage 608 (e.g., FLASH), and network interface 610. The central processor 602, for example, can execute computer program code (e.g., an operating system) to implement the invention. An operating system is normally, but necessarily) resident in the system memory 604 during its execution. Other computer systems suitable for use with the invention may include additional or fewer subsystems. For example, another computer system could include more than one processor 602 (i.e., a multi-processor system) or a cache memory.

The various aspects, embodiments, implementations or features of the described embodiments can be used separately or in any combination. Various aspects of the described embodiments can be implemented by software, hardware or a combination of hardware and software.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

What is claimed is:

1. A method of performing a commercial transaction, comprising:
establishing a first secure link over a first air interface by a purchasing device, the first secure link between the purchasing device and a point of sale device;
identifying a second air interface different from the first air interface;
establishing a second secure link over the second air interface, the second secure link between the purchasing device and a backend server; and
conducting, using the second secure link, a secure commercial transaction between the purchasing device and the backend server using payment data secured by a shared secret known to a secure element in the purchasing device and to the backend server.

2. The method of claim 1, wherein the payment data comprises an alias associated with a payment account, and establishing the second secure link comprises:
encrypting the payment data by the secure element at the purchasing device using the shared secret as an encryption key.

3. The method of claim 2, wherein establishing the second secure link comprises:
decrypting, at the backend server, the payment data using the shared secret; and
verifying, at the backend server, the payment data,
wherein verifying includes comparing the payment data to independently known payment data stored at the backend server.

4. The method of claim 3, wherein comparing the payment data to independently known payment data comprises:
retrieving an alias from the decrypted received payment data;
identifying a credit card account associated with the alias;
determining if the alias is associated with the credit card account according to an association stored in a memory of the backend server; and
in response to determining that the alias is associated with the credit card account, approving the commercial transaction.

5. The method of claim 4, wherein comparing the payment data further comprises:
retrieving a counter value from the decrypted retrieved payment data; and
comparing the counter value to an independently known counter value stored in a memory of the backend server.

6. The method of claim 1, wherein establishing the first secure link comprises establishing a near field communication link between the purchasing device and the point of sale device.

7. The method of claim 1, wherein identifying a second air interface different from the first air interface includes identifying an air interface having properties more desirable than the first air interface for communication of data to a user over a time period longer than the time used to establish the first secure link.

8. A system comprising:
a purchasing device
point of sale device; and
a backend server;
the purchasing device configured to:
establish a secure link over a first air interface, the secure link between the purchasing device and a point of sale device; and
identify a second air interface different from the first air interface, the second air interface being used to conduct a secure commercial transaction between the purchasing device and a backend server using payment data secured by a shared secret known to a secure element in the purchasing device and to the backend server.

9. The system of claim 8, wherein the payment data comprises an alias associated with a payment account, the purchasing device further configured to use a secure element to encrypt the payment data using the shared secret as an encryption key.

10. The system of claim 9, wherein the backend is configured to:
decrypt the payment data using the shared secret; and
compare the payment data to independently known payment data.

11. The system of claim 10, wherein to comparing the payment data the backend server is configured to:
retrieve an alias from the decrypted received payment data;
identify a credit card account associated with the alias;
determine if the alias is associated with the credit card account according to an association stored in a memory of the backend server; and
in response to a determination that the alias is associated with the credit card account, approve the commercial transact.

12. The system of claim 11, wherein to compare the payment data, the backend server is further configured to:
retrieve a counter value from the decrypted retrieved payment data; and
compare the counter value to an independently known counter value stored in a memory of the backend server.

13. The system of claim 8, wherein the second air interface is established using a security key exchanged between the purchasing device and the backend server via the first air interface.

14. The system of claim 8, wherein to identify the second air interface different from the first air interface, the purchasing device is configured to identify an air interface having properties desirable for communicating data over a longer period of time more conveniently to a user than the first air interface.

15. A non-transitory computer readable medium for a computer system, the non-transitory computer readable medium having stored thereon computer program code executable by a processor, the computer program code comprising:
computer program code configured to cause the processor to establish a first secure link over a first air interface by a purchasing device, the first secure link between the purchasing device and a point of sale device,
computer program code configured to cause the processor to identify a second air interface different from the first air interface;
computer program code configured to cause the processor to establish a second secure link over a second air interface, the second secure link between the purchasing device and a backend server; and
computer program code configured to cause the processor to conduct, using the second air interface, a secure commercial transaction between the purchasing device and the backend server using payment data secured by a shared secret known to a secure element in the purchasing device and to the backend server.

16. The computer readable medium of claim 15, wherein the payment data comprises an alias associated with a payment account, and the computer program code configured to establish the second secure link comprises:
computer program code configured to encrypt the payment data by the secure element at the purchasing device using the shared secret as an encryption key.

17. The computer readable medium of claim 16, wherein the computer program code configured to establish the second secure link comprises:
computer program code configured to decrypt, at the backend server, the payment data using the shared secret; and
computer program code configured to compare the payment data to independently known payment data stored at the backend server.

18. The computer readable medium of claim 17, wherein the computer program code configured to compare the payment data to independently known payment data comprises:
computer program code configured to retrieve an alias from the decrypted received payment data;
computer program code configured to identify a credit card account associated with the alias;
computer program code configured to determine if the alias is associated with the credit card account according to an association stored in a memory of the backend server; and
computer program code configured to in response to determining that the alias is associated with the credit card account, approve the commercial transact.

19. The computer readable medium of claim 18, wherein computer program code configured to compare the payment data further comprises:
computer program code configured to retrieve a counter value from the decrypted retrieved payment data; and
computer program code configured to compare the counter value to an independently known counter value stored in a memory of the backend server.

20. The computer readable medium of claim 15, wherein the computer program code configured to establish the first secure link comprises computer program code configured to establish a near field communication link between the purchasing device and the point of sale device.
